(19) United States
(12) Patent Application Publication
(10) Pub. No.: US 2026/0353114 A1
(43) Pub. Date: Nov. 5, 2026

(54) MACHINE LEARNING BASED INTERMODULATION DISTORTION (IMD) MITIGATION IN WIRELESS COMMUNICATION NETWORKS

(71) Applicant: T-MOBILE INNOVATIONS LLC, Overland Park, KS (US)

(72) Inventor: Wafik Abdelshahid, Kenmore, WA (US)

(21) Appl. No.: 19/024,560

(22) Filed: Jan. 16, 2025

(51) Int. Cl. H04W 24/04; H04B 17/336; H04W 72/1268

(52) U.S. Cl. CPC H04W 24/04; H04B 17/336; H04W 72/1268

(57) ABSTRACT

Various embodiments include a system that comprises processing circuitry in a wireless access node. The processing circuitry generates feature vectors based on a transmit power metric and Signal-To-Interference-Plus Noise Ratio (SINR) metric for a wireless access node. The processing circuitry processed the feature vectors using a machine learning model to generate a machine learning output that predicts an uplink Physical Resource Block (PRB) allocation. The machine learning model is trained to determine uplink PRB allocations based on metrics of wireless access nodes. The metrics include transmit power metrics and SINR metrics. The processing circuitry schedules uplink PRBs based on the uplink PRB allocation determined by the machine learning model.

### TECHNICAL FIELD

Various embodiments of the present technology relate to wireless interference mitigation, and more specifically, to utilizing a machine learning model trained to schedule Physical Resource Blocks (PRBs) to mitigate Intermodulation Distortion (IMD).

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless access nodes provide service to user devices in geographic areas referred to as cells. Each cell utilizes one or more radio frequency bands to serve the user devices. The radio frequency bands that link the wireless access nodes and user devices are divided into sections of frequency referred to as Physical Resource Blocks (PRBs). The wireless access nodes schedule the user devices for uplink and downlink transmissions in the PRBs to exchange data and signaling between the user devices and the wireless access nodes.

Intermodulation Distortion (IMD) occurs when two or more signals mix together in a system and produce additional frequencies that are not present in the original signals. Excessive IMD in wireless access nodes distorts and degrades wireless signals inhibiting the effective exchange of signaling and data between the access nodes and the user devices. Increasing the bandwidth supported by a wireless access node increases the likelihood that the wireless access node will experience excessive IMD. Moreover, certain arrangements of uplink PRBs increase the likelihood that the wireless access node will experience excessive IMD.

Desensitization is a form of interference where a radio receiver is unable to receive a radio signal that it would otherwise be able to receive without interference. Desensitization occurs when a transmitter proximate to the receiver emits a strong signal on a close frequency to the received signal's frequency. Desensitization in wireless access nodes inhibits the wireless access nodes from effectively receiving wireless signals from user devices. Increasing the transmit power in a wireless access node to increase the downlink coverage area of the wireless access node increases the likelihood that the wireless access node receiver will experience desensitization. IMD and desensitization in wireless access nodes degrades the overall user experience.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for wireless interference mitigation. Some embodiments comprise a method. The method comprises generating feature vectors based on a transmit power metric and Signal-To-Interference-Plus Noise Ratio (SINR) metric for a wireless access node. The method further comprises processing the feature vectors using a machine learning model to generate a machine learning output that predicts an uplink Physical Resource Block (PRB) allocation. The machine learning model is trained to determine uplink PRB allocations based on metrics of wireless access nodes. The metrics include transmit power metrics and SINR metrics. The method further comprises scheduling uplink PRBs based on the uplink PRB allocation determined by the machine learning model.

Some embodiments comprise a system. The system comprises processing circuitry in a wireless access node. The processing circuitry generates feature vectors based on a transmit power metric and Signal-To-Interference-Plus Noise Ratio (SINR) metric for a wireless access node. The processing circuitry processed the feature vectors using a machine learning model to generate a machine learning output that predicts an uplink Physical Resource Block (PRB) allocation. The machine learning model is trained to determine uplink PRB allocations based on metrics of wireless access nodes. The metrics include transmit power metrics and SINR metrics. The processing circuitry schedules uplink PRBs based on the uplink PRB allocation determined by the machine learning model.

Some embodiments comprise one or more non-transitory computer readable storage media having program instructions stored thereon. When executed by a computing system, the program instructions direct the computing system to perform operations. The operations comprise generating feature vectors based on a transmit power metric and Signal-To-Interference-Plus Noise Ratio (SINR) metric for a wireless access node. The operations further comprise processing the feature vectors using a machine learning model to generate a machine learning output that predicts an uplink Physical Resource Block (PRB) allocation. The machine learning model is trained to determine uplink PRB allocations based on metrics of wireless access nodes. The metrics include transmit power metrics and SINR metrics. The operations further comprise scheduling uplink PRBs based on the uplink PRB allocation determined by the machine learning model.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a communication network to utilize a machine learning model to mitigate Intermodulation Distortion (IMD).

FIG. 2 illustrates an exemplary operation of the communication network to utilize a machine learning model to mitigate IMD.

FIG. 3 illustrates another exemplary operation of the communication network to utilize a machine learning model to mitigate IMD.

FIG. 4 illustrates an example of an access node in the communication network to utilize a machine learning model to mitigate IMD.

FIG. 5 illustrates an example of a Fifth Generation (5G) communication network to utilize a machine learning model to mitigate IMD.

FIG. 6 illustrates an example of a 5G User Equipment (UE) in the 5G communication network that utilizes a machine learning model to mitigate IMD.

FIG. 7 illustrates an example of a 5G gNodeB in the 5G communication network that utilizes a machine learning model to mitigate IMD.

FIG. 8 illustrates an example of a 5G data center in the 5G communication network that utilizes a machine learning model to mitigate IMD.

FIG. 9 illustrates an exemplary operation of the 5G communication network to utilize a machine learning model to mitigate IMD.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

In conventional wireless communication networks, wireless access nodes schedule user devices to receive and transmit data and signaling in Physical Resource Blocks (PRBs). The PRBs comprise frequency domain resources the wireless access nodes use to encode the data/signaling and time domain resources to control transmission/reception time. The wireless access nodes transfer the downlink data to the user devices and receive the uplink user data from the user devices based on the PRB scheduling. Some wireless access nodes support symmetric radio frequency bands. In a symmetric radio frequency band, half of the band is reserved for uplink PRBs while the other half of the band is reserved for downlink PRBs. It is advantageous to expand the bandwidth and the transmit power supported by wireless access nodes as this expands the throughput and coverage of the access nodes.

However, expanding symmetric radio frequency bands causes Intermodulation Distortion (IMD) in the wireless access node. The IMD causes downlink signals broadcast from the access node to be present in uplink signals received by the access node. Moreover, expanding the transmit power of the wireless access node can desensitize the access node's receiver. The introduction of IMD causes the access node to either reduce downlink transmit power which reduces the coverage area of the access node or to shrink the uplink bandwidth which reduces uplink throughput. The introduction of desensitization causes the access node to reduce transmit power which reduces the coverage area of the access node. These reductions in coverage and throughput make increasing the bandwidth and transmit power supported by a wireless access node to be infeasible.

To overcome the above-described problems in conventional wireless communication networks, various embodiments of the present technology relate to utilizing a machine learning model trained to schedule resource blocks to mitigate Intermodulation Distortion (IMD) and receiver desensitization. In some examples, a wireless access node hosts a machine learning model that is trained to select downlink transmit powers and uplink PRB allocations to mitigate IMD as well as receiver desensitization. Some uplink PRB allocations are more likely to cause IMD in access nodes than other uplink PRB allocations. The access node generates feature vectors that numerically represent the Signal-To-Noise-Plus-Interference Ratio (SINR) and current transmit power of the access node. The access node provides the feature vectors to the machine learning model. The model processes the feature vectors to generate a machine learning output. The output recommends a downlink transmit power and an uplink PRB allocation. The access node sets its transmit power and schedules uplink PRBs based on the model's recommendation. This efficient uplink PRB scheduling allows for the use of larger symmetric bandwidths and larger transmit powers by wireless access nodes which increases the throughput and coverage of the access nodes. The increase in throughput and coverage enhances the overall user experience. Now referring to the Figures.

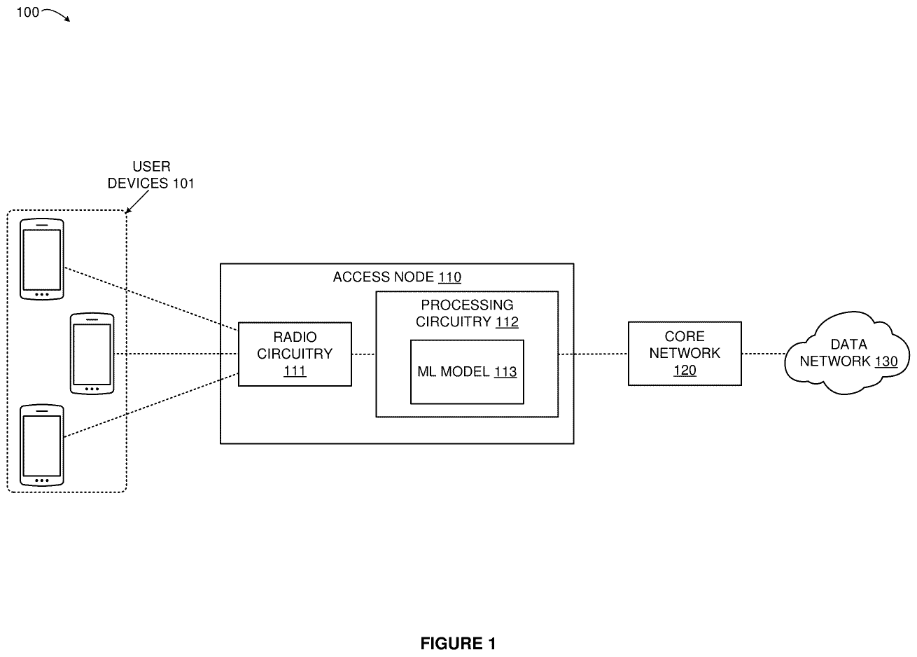

FIG. 1 illustrates communication network 100 to utilize a machine learning model to mitigate IMD. Communication network 100 provides services like media-streaming, media-broadcasting, internet-access, voice/video calling, text messaging, online gaming, social media, machine communications, remote device control, or some other wireless communications product. Communication network 100 comprises user devices 101, access node 110, core network 120, and data network 130. Access node 110 comprises radio circuitry 111 and processing circuitry 112. Processing circuitry 112 hosts machine learning (ML) model 113. In other examples, communication network 100 may comprise additional or different elements than those illustrated in FIG. 1.

Various examples of network operation and configuration are described herein. In some examples, user devices 101 attach to access node 110 over radio circuitry 111. Processing circuitry 112 exchanges signaling with user devices 101 to establish wireless data and signaling links. User devices 101 communicate with core network 120 over access node 110 to request wireless data services over access node 110. Core network 120 approves the service requests and directs access node 110 to serve user devices 101. User devices 101 wirelessly exchange user data with processing circuitry 112 over radio circuitry 111. Processing circuitry 112 exchanges the user data with core network 120. Core network 120 exchanges the user data with data network 130.

Access node 110 and user devices 101 communicate over radio frequency bands. The radio frequency bands comprise a range of radio spectrum with radio channels for wireless communication. For example, the N41 radio frequency band is a Fifth Generation New Radio (5GNR) frequency band that spans 2496-2690 MHz. The span of the radio frequency band is referred to as the bandwidth. The radio channels in the frequency band are divided into subcarriers which comprise chunks of bandwidth. Adjacent subcarriers are grouped to form Physical Resource Blocks (PRBs). Each PRB typically comprises 12 subcarriers. Processing circuitry 112 schedules user devices 101 to send and receive wireless signals in the PRBs and controls radio circuitry 111 to encode signaling/data for user devices 101 in the subcarriers of the scheduled PRBs. Typically, a portion of the radio frequency band(s) supported by access node 110 is reserved for downlink transmissions (e.g., from access node 110 to user devices 101) while another portion of the radio frequency band(s) supported by access node 110 is reserved for uplink transmissions. Signaling and data transferred by access node 110 to user devices 101 is scheduled in downlink PRBs. Likewise, signaling and data transferred by user devices 101 to access node 110 is scheduled in uplink PRBs.

Processing circuitry 112 controls and tracks the transmit power of radio circuitry 111. Processing circuitry 112 controls radio circuitry 111 to measure SINR at the location of access node 110. Processing circuitry 112 generates feature vectors that numerically represent the transmit power of radio circuitry 111 and the SINR at the location of access node 110. Processing circuitry 112 provides the feature vectors to machine learning model 113. Machine learning model 113 is trained to recommend uplink PRB allocations to inhibit or otherwise mitigate IMD in the wireless signals received by radio circuitry 111 based on the transmit power of radio circuitry 111 and the SINR at the location of access node 110. Machine learning model 113 generates a machine learning output that recommends an uplink PRB allocation for user devices 101. Generally, machine learning model 113 recommends an uplink PRB allocation that maximizes use of uplink bandwidth without introducing IMD into the receiver of radio circuitry 111. Processing circuitry 112 schedules user devices 101 for uplink transmissions in the PRBs recommended by machine learning model 113.

In some examples, processing circuitry 112 trains machine learning model 113 to allocate uplink PRBs to inhibit or otherwise mitigate IMD on the receiver of radio circuitry 111 based on historical data. Exemplary historical data that may be used to train machine learning model 113 includes historical transmit powers, historical SINRs, historical uplink PRB allocations, historical receiver IMD, and/or other information that characterizes the operation of access node 110. Processing circuitry 112 generates training feature vectors that represent the historical data to form a training data set. Processing circuitry 112 provides the training data set to machine learning model 113. Machine learning model 113 processes the training feature vectors included in the training data set to advance the training state of its constituent machine learning algorithms. For example, machine learning model 113 may produce training outputs that recommend uplink PRB allocations and predict decreases in IMD on the receiver of radio circuitry 111. Machine learning model 113 may then compare the recommended PRB allocations and predicted decreases in IMD with historical PRB allocations and historical IMD levels to determine the accuracy of the prediction. For example, machine learning model 113 may train its algorithms to correlate reductions in the historical IMD at corresponding ones of the historical transmit powers and ones of the historical SINRs with ones of the historical uplink PRB allocations. Machine learning model 113 may then adjust the weights of its algorithms to attempt to improve the accuracy of future predictions. This training process may continue until the accuracy of the predictions is sufficient (e.g., exceeds an operator defined threshold). While machine learning model 113 is described as being trained to recommend uplink PRB allocations that maximize uplink bandwidth usage without introducing receiver IMD, in some examples machine learning model 113 may be further trained to recommend uplink PRB allocations that reduce Block Error Rate (BLER) and reduce retransmission in addition to maximizing uplink bandwidth usage without introducing receiver IMD.

In some examples, machine learning model 113 may be trained to recommend downlink transmission power levels for radio circuitry 111 that inhibit or otherwise mitigate desensitization in the receiver of radio circuitry 111. For example, processing circuitry 112 may provide machine learning model 113 with training feature vectors that represent historical downlink transmit power levels and historical periods of receiver desensitization and machine learning model 113 may train its algorithms to determine the transmit power level that results in receiver desensitization. When its training state is sufficient, machine learning model 113 may generate machine learning outputs that recommend uplink PRB allocations and downlink transmitter powers based on the SINR and transmit power of access node 110. Generally, machine learning model 113 recommends a downlink transmit power that maximizes the downlink transmit power without desensitizing the receiver of radio circuitry 111. Processing circuitry 112 may set the transmit power of radio circuitry 112 to the recommended power level and schedule user devices 101 for uplink transmissions in the recommended PRBs to mitigate IMD and desensitization in the receiver of radio circuitry 111.

In some examples, machine learning model 113 may be trained to predict upcoming radio resource requirements to support uplink and downlink communications with user devices 101. For example, processing circuitry 112 may provide training feature vectors that represent historical cell loading, time, day of the week, date, and/or other historical metrics that characterize the radio resources required to support communications with user devices 101. Machine learning model 113 may process the training feature vectors to train its algorithms to predict upcoming radio resource requirements based on current cell loading, time, day, date, and the like. When its training state is sufficient, machine learning model 113 may generate machine learning outputs that predict the needed radio resources to support communications with user devices 101 in the near term (e.g., the next 0.5-10 minutes). Processing circuitry 112 may reserve radio resources for upcoming transmission periods based on the required radio resources predicted by machine learning model 113.

Advantageously, communication network 100 effectively utilizes a machine learning model to recommend uplink PRB allocations to mitigate IMD in wireless access nodes. Moreover, the efficient uplink PRB scheduling allows for the use of increased bandwidth by the wireless access nodes which increases network throughput and enhances the overall user experience.

User devices 101 may comprise phones, computers, vehicles, drones, robots, sensors, or other types of data appliances with wireless and/or wireline communication circuitry. User devices 101 and access node 110 may communicate over links using wireless/wireline technologies like Sixth Generation Radio (6GR), 5GNR, Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Access node 110 may comprise a tower, another type of mounting structure (e.g., a building), or no mounting structure at all. Access node 110 may comprise a Sixth Generation (6G) Radio Access Network (RAN) node, Fifth Generation (5G) RAN node, LTE RAN node, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Although access node 110 is illustrated as comprising a terrestrial access node, in some examples access node 110 may comprise a non-terrestrial (e.g., satellite based) access node. Access node 110 exchanges network signaling and user data with network functions clustered together into core network 120. Access node 110 is connected to core network 120 over one or more backhaul data links. Access node 110 and core network 120 may communicate via edge networks like internet backbone providers, edge computing systems, or another type of edge system to provide the backhaul data and signaling links between access node 110 and core network 120.

Access node 110 may comprise Radio Units (RUs), Distributed Units (DUs) and Centralized Units (CUs). For example, processing circuitry 112 may be representative of a DU and a CU while radio circuitry 111 may be representative of an RU. The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120.

A machine learning model comprises one or more machine learning algorithms that are trained to produce outputs based on historical data and/or other types of training data. A machine learning model may employ one or more machine learning algorithms through which data can be analyzed to identify patterns, make decisions, make predictions, or similarly produce output. Machine leaning model 113 may comprise one or more Three Dimensional (3D) deep leaning models, 3D convolutional neural networks, times series convolutional deep learning, transformers, multi-layer perceptron, long term short memory, attention based deep learning model, artificial neural networks, nearest neighbor methods, ensemble random forests, support vector machines, naïve Bayes methods, linear regressions, or similar machine learning techniques or combinations thereof capable of predicting output based on input data.

Core network 120 is representative of computing systems that provide wireless data services to user devices 101 over access node 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access node 110, core network 120, and data network 130 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 120 store and execute the network functions/entities to form a control plane and a user plane. Exemplary control plane network functions include Access and Mobility Management Function (AMF), Session Management Function (SMF), Unified Data Management (UDM), Policy Control Function (PCF), Mobility Management Entity (MME), Policy and Rules Charging Function (PCRF), Home Subscriber Server (HSS), and the like. Exemplary user plane network functions include User Plane Functions (UPF), Packet Gateway (P-GW), Serving Gateway (S-GW), and the like.

Data network 130 comprises application servers, gateways, routers, Content Distribution Networks (CNDs) and/or other communication devices to participate in data sessions with user devices 101. For example, data network 130 may comprise an application server that hosts the server-side component of a user application executing on user devices 101. Data network 130 may be representative of a public data network (e.g., the Internet) or a private data network (e.g., an enterprise network). Core network 120 and data network 130 may communicate via links provided by internet backbone providers, edge computing services, and/or other communication services that provide the data links between core network 120 and data network 130.

User devices 101 and access node 110 comprise antennas, amplifiers, filters, modulation, analog/digital interfaces, microprocessors, software, memories, transceivers, bus circuitry, and the like. User devices 101, access node 110, core network 120, and data network 130 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

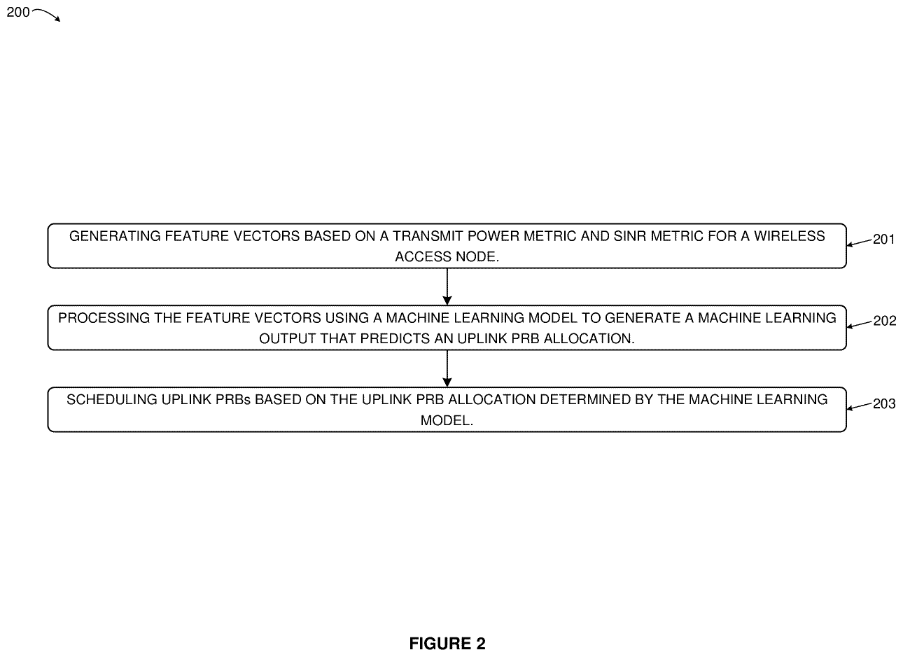

FIG. 2 illustrates process 200. Process 200 comprises an exemplary operation of communication network 100 to utilize a machine learning model to mitigate IMD. Process 200 may vary in other examples. The operations of process 200 comprise generating feature vectors based on a transmit power metric and SINR metric for a wireless access node (step 201). The operations further comprise processing the feature vectors using a machine learning model to generate a machine learning output that predicts an uplink PRB allocation (step 202). The machine learning model is trained to determine uplink PRB allocations based on metrics of wireless access nodes. The metrics include transmit power metrics and SINR metrics. The operations further comprise scheduling uplink PRBs based on the uplink PRB allocation determined by the machine learning model (step 203).

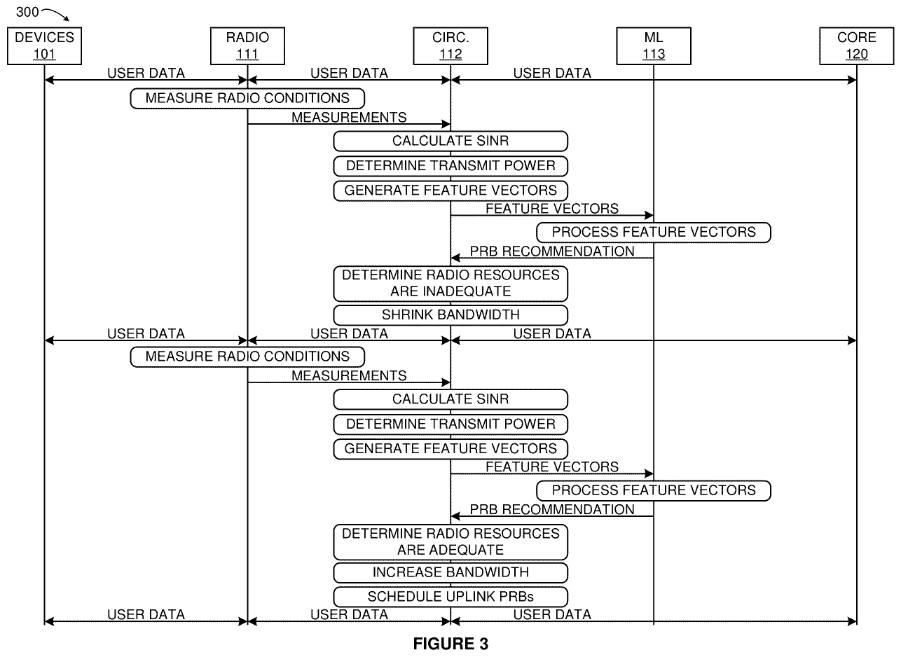

FIG. 3 illustrates process 300. Process 300 comprises an exemplary operation of communication network 100 to utilize a machine learning model to mitigate IMD. Process 300 comprises an example of process 200 illustrated in FIG. 2, however process 200 may differ. Process 300 may vary in other examples. In some examples, radio circuitry 111 broadcasts reference signals. The reference signals include information which is used by user devices to initiate communications with access node 110. User devices 101 receive the reference signals and measure signal strength of the signals. When the signal strength of the reference signals exceeds quality and/or strength thresholds (e.g., Received Signal Received Power (RSRP) thresholds, Received Signal Received Quality (RSRQ) thresholds, etc.), user devices 101 decide to attach to access node 110.

User devices 101 transfer attachment signaling to processing circuitry (CIRC) 112 over radio circuitry 111 based on the reference signals. Processing circuitry 112 returns random access responses to user devices 101 over radio circuitry 111. The responses comprise information like a timing advance command, uplink grant, and temporary identifier. User devices 101 generate and transfer connection setup requests using the uplink grants at the times specified by the timing advance command to processing circuitry 112 over radio circuitry 111. For example, the connection setup requests may comprise Radio Resource Control (RRC) setup requests. Processing circuitry 112 allocates radio resources to user devices 101 to establish the wireless connections with user devices 101.

In response to connection setup, user devices 101 transfer registration requests to core network 120 over access node 110. The registration request includes information like subscriber Identifier (ID), device capabilities, Protocol Data Unit (PDU) session request requests, and the like. Core network 120 authenticates user devices 101 and authorizes user devices 101 for service on communication network 100. Responsive to authentication and authorization, core network 120 registers user devices 101 for service on communication network 100. Core network 120 directs processing circuitry 112 to serve user devices 101 and transfers registration accept messages for user devices 101 to processing circuitry 112. The registration accept messages include information like device context, network addresses, and/or other information for user devices 101 to begin their respective data sessions.

Processing circuitry 112 transfers the registration accept messages to user devices 101 over radio circuitry 111. Processing circuitry 112 schedules user devices 101 in uplink and downlink PRBs for data reception/transmission. Processing circuitry 112 controls radio circuitry 111 to wirelessly exchange user data with user devices 101 based on the scheduling. Processing circuitry 112 controls the transmission power of radio circuitry 111 to deliver downlink signaling and data to user devices 101. Processing circuitry 112 exchanges the user data with core network 120 which in turn exchanges the user data with data network 130.

Access node 110 begins experiencing IMD and/or desensitization on the receiver of radio circuitry 111. For example, access node 110 may support a symmetric radio band with equal parts of the band dedicated to uplink and downlink transmissions (e.g., 35 MHz dedicated to uplink and 35 MHz dedicated to downlink). The symmetry of the band may cause IMD on the receiver of radio circuitry 111. Alternatively, a large proportion of user devices 101 may be located at the cell edge (e.g., geographically distant from access node 110). The concentration of user devices 101 at the cell edge may cause access node 110 to increase the downlink transmission power of radio circuitry 111 resulting in desensitization of radio circuitry 111 on the uplink.

Processing circuitry 112 initiates IMD and desensitization mitigation in response to the introduction of IMD and/or desensitization on the receiver of radio circuitry 111. Processing circuitry 112 controls radio circuitry 111 to measure signal metrics like received signal power, received interference power, and noise. Radio circuitry 111 reports the measured signal metrics to processing circuitry 112. Processing circuitry 112 calculates SINR at the location of access node 110 based on the measured received signal power, received interference power, and noise. Processing circuitry 112 tracks the transmit power of radio circuitry 111. Processing circuitry 112 generates feature vectors that numerically represent the transmission power of radio circuitry 111 and the SINR at the location of access node 110. A feature vector is an n-dimensional string of numbers that represents a piece of data in a format interpretable by a machine learning model. Processing circuitry 112 loads the feature vectors to machine learning model 113. Machine learning model 113 processes the feature vectors using its constituent machine learning algorithms to generate a machine learning output. The machine learning output recommends an uplink PRB allocation to mitigate IMD in the signals received by radio circuitry 111 and recommends a downlink transmit power for radio circuitry 111 that mitigates receiver desensitization on radio circuitry 111. Machine learning model 113 provides the output to processing circuitry 112.

Processing circuitry 112 compares the amount of radio resources available for uplink PRB scheduling to the PRB allocation and determines the amount of radio resources required to support uplink transmission is greater than the amount of radio resource required for the recommended PRB allocation. When the amount of radio resources available for uplink PRB scheduling is less than the amount of radio resources required to implement the uplink PRB allocation recommended by machine learning model 113, processing circuitry 112 decides to shrink the bandwidth supported by access node 110 to mitigate receiver IMD on radio circuitry 111. Processing circuitry 112 may shrink the bandwidth dedicated to the uplink or shrink the entire band to mitigate received IMD. For example, access node 110 may support a total of 200 PRBs with 100 PRBs dedicated to the uplink and 100 PRBs dedicated to the downlink and the amount of user devices 101 connected to access node 110 may require 85 PRBs for uplink transmission. However, machine learning model 113 may recommend an uplink PRB allocation of 70 PRBs that minimizes IMD. Since the amount of PRBs required to communicate with user devices 101 is greater than the optimal uplink PRB allocation, processing circuitry 112 elects to reduce the number of available uplink PRBs (e.g., from 100 to 80) to counter IMD on the receiver of radio circuitry 111. Processing circuitry 112 continues to control radio circuitry 111 to wirelessly exchange user data with user devices 101. Processing circuitry 112 continues to exchange the user data with core network 120. Processing circuitry 112 monitors cell conditions (e.g., cell edge loading) to detect when cell conditions improve.

Subsequently, processing circuitry 112 detects the radio conditions in the cell served by access node 110 have improved. For example, processing circuitry 112 may calculate the distance between user devices 101 and access node 110 (e.g., based on the timing-advance signal) and determine the concentration user devices 101 at the cell edge has lowered. Processing circuitry 112 controls radio circuitry 111 to measure received signal power, received interference power, and noise and calculates SINR based on the measured signal characteristics. Processing circuitry 112 determines the transmit power of radio circuitry 111. Processing circuitry 112 generates new feature vectors that numerically represent the transmit power and SINR of access node 110. Processing circuitry 112 provides the feature vectors to machine learning model 113 which processes the feature vectors to generate a machine learning output that recommends an uplink PRB allocation and downlink transmit power to mitigate IMD and desensitization on radio circuitry 111. Machine learning model 113 provides the output to processing circuitry 112.

Processing circuitry 112 compares the amount of radio resources available for uplink PRB scheduling to the PRB allocation and determines the amount of radio resources required to support uplink transmission is less than the amount of radio resource required for the recommended PRB allocation. In response, processing circuitry 112 sets the transmit power of radio circuitry 111 based on the recommendation and schedules user devices 101 to transmit in the uplink PRBs recommended by machine learning model 113. Processing circuitry 112 controls radio circuitry 111 to wirelessly deliver uplink grants to user devices 101. The uplink grants direct user devices 101 to transmit uplink signaling and data in the uplink PRBs scheduled by processing circuitry 112. Processing circuitry 112 continues to control radio circuitry 111 to wirelessly exchange user data with user devices 101. Processing circuitry 112 continues to exchange the user data with core network 120.

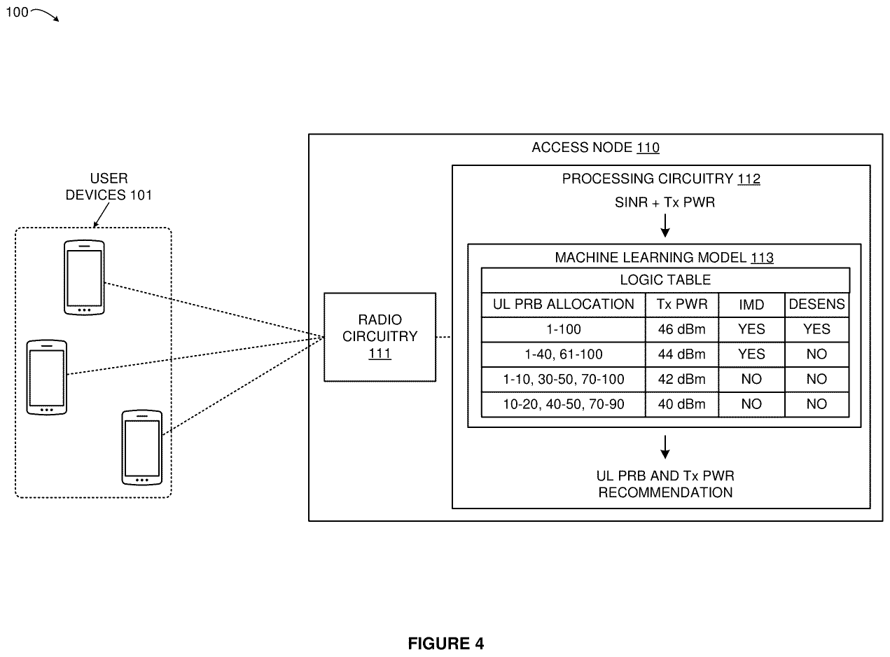

FIG. 4 illustrates access node 110 in communication network 100. In some examples, access node 110 provides a cell the serves user devices 101 on a radio band. Exemplary radio bands comprise N41, N25, and N71. N71 is a Frequency Division Duplex (FDD) 5G 600 MHz low-band frequency band. N25 is an FDD 5G 1900 MHz mid-band frequency band. N41 is a Time Division Duplex (TDD) 5G 2500 MHz mid-band frequency band. Other exemplary bands include the mid-band FDD 2100 MHz (N66), the mid-band TDD 3700 MHz (N77), the high-band Millimeter Wave (mmWave) TDD 24 GHz band, and the high-band mmWave 36 GHz band. The radio bands are divided into a number of PRBs depending on the bandwidth. In this example, the cell's radio band comprises 100 total PRBs, however this number is exemplary and may differ in other examples.

When the transmitter power level of radio circuitry 111 is too high, the receiver of radio circuitry 111 can become desensitized to signals that it would otherwise be able to detect. Moreover, certain combinations of uplink PRBs, particularly in symmetric radio bands, can result in IMD in the receiver of radio circuitry 111. As such, processing circuitry 112 hosts machine learning model 113 to mitigate receiver IMD and desensitization.

Processing circuitry 112 provides SINR and transmit power (Tx PWR) of access node 110 to machine learning model 113. The algorithms of machine learning model are trained to learn the correlations depicted in the logic table illustrated in FIG. 4 given the input SINR and transmit power. It should be appreciated that the logic table is exemplary and is intended to show examples of relationships learned by machine learning model 113. The values included in the logic table are exemplary and may differ in other examples. The logic table lists combinations of uplink PRB allocations and transmitter power levels and whether these combinations result in receiver IMD and/or desensitization. For example, the first row of the logic table indicates an uplink PRB allocation of PRBs 1-100 and a downlink transmitter power of 46 dBm results in both IMD and desensitization while the third row of the logic table indicates an uplink PRB allocation of PRBs 1-10, 30-50, and 70-100 and a downlink transmitter power of 42 dBm do not result in both IMD and desensitization. Typically, machine learning model 113 learns many more combinations of uplink PRB allocations and transmitter power levels than illustrated in FIG. 4 and whether these combinations result in IMD and/or desensitization given the input SINR and transmitter power level. Machine learning model 113 provides a machine learning output to processing circuitry 112 that recommends an uplink PRB allocation and transmitter power level. Processing circuitry 112 schedules user devices 101 for uplink transmission based on the recommended PRB allocation and sets the transmitter power level of radio circuitry 111 based on the recommended transmitter power level.

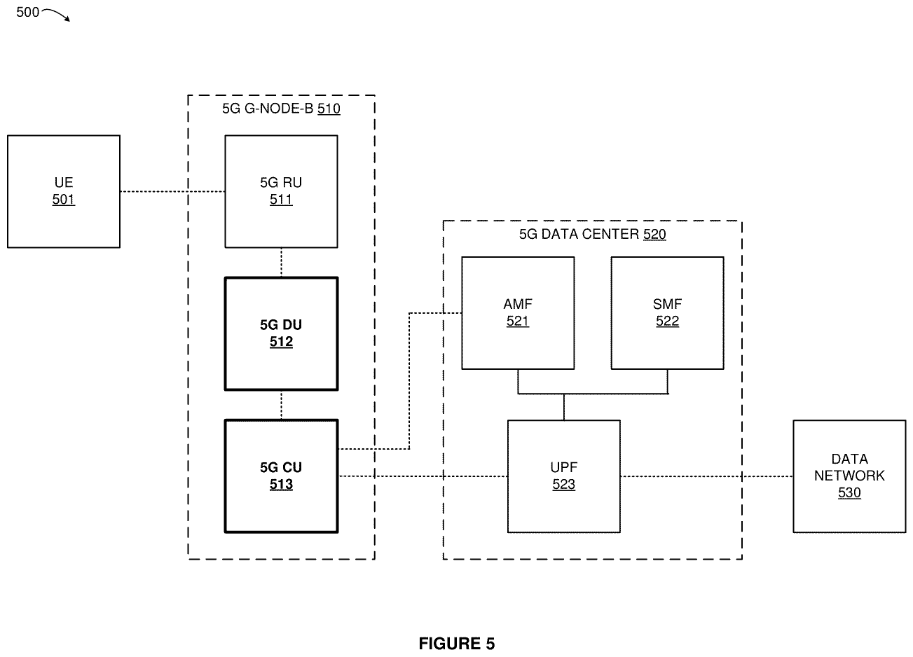

FIG. 5 illustrates 5G communication network 500 to utilize a machine learning model to mitigate IMD. 5G communication network 500 comprises an example of communication network 100 illustrated in FIG. 1, however communication network 100 may differ. 5G communication network 500 comprises 5G UE 501, 5G gNodeB 510, 5G data center 520, and data network 530. 5G gNodeB 510 comprises 5G RU 511, 5G DU 512, and 5G CU 513. 5G data center 520 comprises AMF 521, SMF 522, and UPF 523. Other network functions and network entities like PCF, UDM, Authentication Server Function (AUSF), Network Slice Selection Function (NSSF), Charging Function (CHF), Home Subscriber Register (HLR), HSS, Network Repository Function (NRF), Unified Data Registry (UDR), Short Message Service Function (SMSF), Network Exposure Function (NEF), Application Function (AF), Equipment Identity Register (EIR), and Session Communication Proxy (SCP) are typically present in 5G data center 520 but are omitted for clarity. In other examples, 5G communication network 500 may comprise different or additional elements than those illustrated in FIG. 5.

In some examples, 5G gNodeB 510 serves UE 501 over radio a channel in a cell. 5G gNodeB 510 typically serves other UEs in its cell however the other UEs are omitted for clarity. UE 501 detects a synchronization signal broadcast by 5G gNodeB 510 and decides to attach. UE 501 wirelessly attaches to 5G gNodeB 510 over a 5GNR link and transfers random preamble to 5G gNodeB 510 initiating a Random Access Channel (RACH) procedure to establish a secure signaling channel. 5G gNodeB 510 receives the preamble and assigns a Cell-Radio Network Temporary Identifier (C-RNTI) to UE 501. 5G gNodeB 510 wirelessly transfers a random access response to UE 501. The random access response includes a timing advance command, uplink grant, and the C-RNTI. The uplink grant indicates the time and frequency domain resources assigned to UE 501. UE 501 wirelessly receives the random access response. UE 501 extracts the uplink grant and timing advance command from the response. UE 501 transfers an RRC setup request to 5G gNodeB 510 using the frequency and time resources assigned by the uplink grant at the time indicated by the timing advance command. The RRC setup request comprises a UE identity indication and the establishment cause. 5G gNodeB 510 establishes a radio signaling bearer for UE 501 and transfers an RRC setup message to UE 501. The RRC setup message comprises a radio bearer configuration and cell ID. UE 501 establishes an RRC connection with 5G gNodeB 510 using the radio bearer configuration and cell ID.

UE 501 transfers a registration request to AMF 521 over 5G gNodeB 510 and the radio signaling bearer. The registration request indicates a registration type, 5G-Global Unique Temporary Identifier (GUTI), Tracking Area Identifier (TAI), Network Slice Selection Assistance Information (NSSAI) requests, UE capabilities, PDU session requests, and the like. In response to the registration request, AMF 521 transfers a Non-Access Stratum (NAS) identity request to UE 501 over 5G gNodeB 510 and the radio signaling bearer. UE 501 indicates its Subscriber Concealed Identifier (SUCI) to AMF 521 over 5G gNodeB 510. AMF 521 interfaces with other network functions to authenticate the identity of UE 501. Typically, authentication involves presenting a random number challenge to UE 501 and matching an authentication response from UE 501 with an expected result to verify the identity of UE 501.

Responsive to the authentication, AMF 521 interfaces with other network functions to generate context for UE 501. The UE context defines the authorized services for UE 501. To form the context, AMF 521 retrieves access and mobility subscription data, SMF selection subscription data, and UE context in SMF data from a network data system. The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. AMF 521 forms the UE context for UE 501 using the retrieved information. AMF 521 interfaces with other network functions to retrieve policy association information for UE 501. The policy association information comprises the SUPI, GPSI, PEI, and user location information for UE 501.

AMF 521 selects SMF 522 to serve UE 501 based on SMF selection data, the policy association information, and/or the network slice assigned to UE 501. AMF 521 transfers a list of requested PDU sessions (as received during the registration request), a PDU session activation command, and the SUPI to SMF 522. SMF 522 receives the PDU session list, session activation command, and the SUPI from AMF 521. SMF 522 allocates IP addresses to UE 501 for the requested PDU sessions and allocates a TEID for the session. SMF 522 selects UPF 523 to serve UE 501. SMF 522 transfers a session modification request that includes a session endpoint identifier and TEID to UPF 523 to set up the PDU sessions for UE 501. UPF 523 sets up a default bearer for UE 501 with 5G gNodeB 510. The default bearer is a link to carry IP packets for UE 501's PDU session. UPF 523 transfers a session modification response to SMF 522 that includes the session endpoint identifier to confirm bearer setup.

SMF 522 returns a PDU session create response to AMF 521 to confirm session creation. The response includes the updated session context (e.g., allocated IP addresses, TEID, etc.). In response, AMF 521 registers UE 501 for service on 5G data center 520. AMF 521 generates a registration accept message that includes the allocated UE IP address, RAN ID, AMBR, Globally Unique AMF ID (GUAMI), PDU session ID, PDU session TEID, allowed NSSAI list, security data, and the like. AMF 521 transfers the registration accept message to 5G gNodeB 510 to direct 5G gNodeB 510 to serve UE 501.

5G gNodeB 510 schedules uplink and downlink PRBs for UE 501 to assign time and frequency domain resources for the PDU session based on the registration accept message. 5G gNodeB 510 transfers an RRC reconfiguration message to UE 501 to setup the data radio bearers. The message includes cell IDs, bearer configuration information, and the like. UE 501 configures its radio bearers using the received information. UE 501 begins its PDU session on 5G communication network 500. 5G gNodeB 510 wirelessly exchanges user data with UE 501 using the PRBs assigned to UE 501. 5G gNodeB 510 exchanges the user data with UPF 523 which in turn exchanges the user data with data network 530.

5G gNodeB 510 utilizes a machine learning model hosted by CU 513 to mitigate IMD and desensitization in the receiver of RU 511. The machine learning model is trained to allocate uplink PRBs, select downlink RU transmitter power, and predict radio resource requirements based on measured SINR and current transmitter power to mitigate RU receiver IMD, receiver desensitization, BLER, and retransmission rate. 5G gNodeB 510 measures SINR at the location 5G gNodeB 510 and determines the downlink transmission power of RU 511. 5G gNodeB 510 generates feature vectors that represent the SINR and downlink transmission power and processes the feature vectors using the machine learning model. The machine learning model outputs a recommended uplink PRB allocation and recommended downlink transmit power that mitigates RU receiver IMD, receiver desensitization, BLER, and retransmission rate. The model output also includes radio resource prediction.

5G gNodeB 510 schedules additional downlink PRBs for UE 501 and additional uplink PRBs for UE 501 using the uplink PRB allocation recommended by the machine learning model to assign time and frequency domain resources for the PDU session. 5G gNodeB 510 wirelessly indicates the uplink and downlink schedules to UE 501. UE 501 continues its PDU session on 5G communication network 500. 5G gNodeB 510 wirelessly exchanges user data with UE 501 using the PRBs assigned to UE 501. 5G gNodeB 510 exchanges the user data with UPF 523 which in turn exchanges the user data with data network 530.

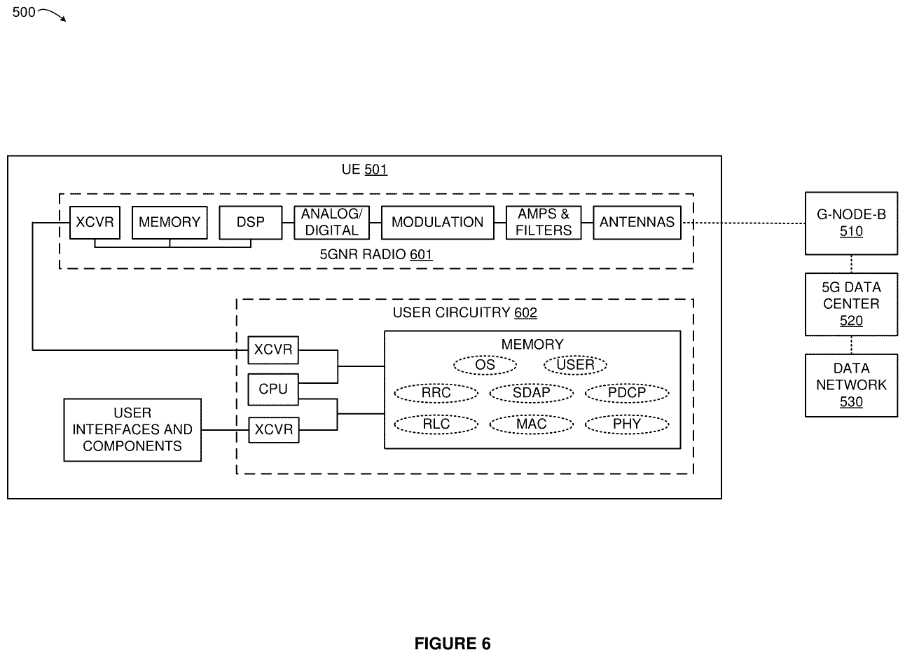

FIG. 6 illustrates UE 501 in 5G communication network 500. UE 501 comprises an example of user devices 101 illustrated in FIG. 1, although user devices 101 may differ. UE 501 comprises 5G radio 601 and user circuitry 602. 5G radio 601 comprises 5GNR antennas, amplifiers, filters, modulation, analog-to-digital interfaces, Digital Signal Processers (DSP), memory, and transceivers (XCVRs) that are coupled over bus circuitry. User circuitry 602 comprises memory, CPU, user interfaces and components, and transceivers that are coupled over bus circuitry.

The memory in user circuitry 602 stores an operating system (OS), user applications (USER), and 5GNR network applications for PHY, MAC, RLC, PDCP, SDAP, and RRC. The antenna in 5G radio 601 is wirelessly coupled to 5G gNodeB 510 over a 5GNR link. Transceivers in radio 601 are coupled to a transceiver in user circuitry 602. A transceiver in user circuitry 602 is typically coupled to user interfaces and components like displays, controllers, and memory.

In 5G radio 601, the antennas receive wireless signals from 5G gNodeB 510 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 602 over the transceivers. In user circuitry 602, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 601, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G gNodeB 510 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

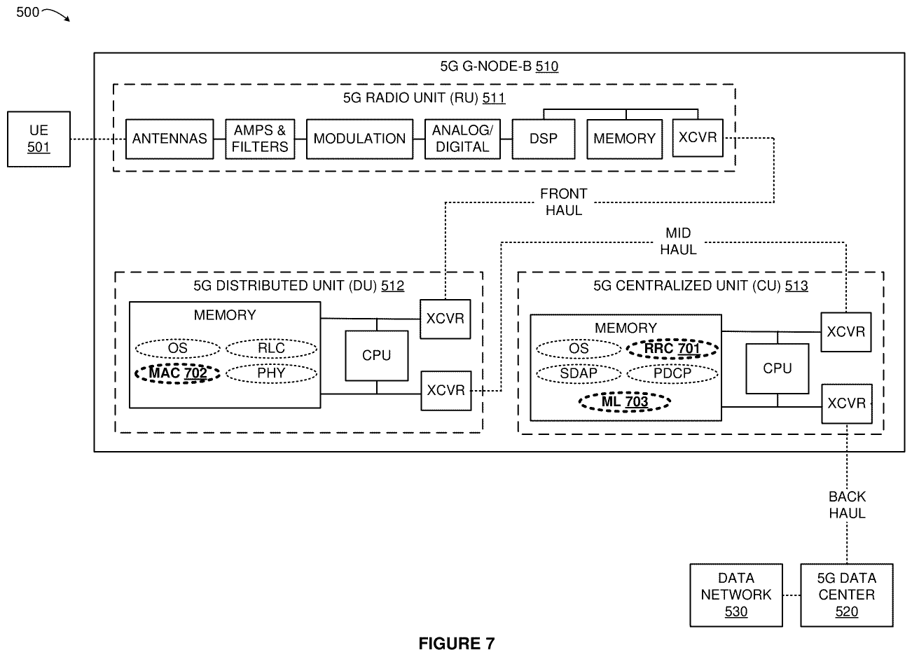

FIG. 7 illustrates 5G gNodeB 510 in 5G communication network 500. 5G gNodeB 510 comprises an example of the access node 110 illustrated in FIG. 1, although access node 110 may differ. RU 511 comprises 5GNR antennas, amplifiers, filters, modulation, analog-to-digital interfaces, DSP, memory, and transceivers (XCVRs) that are coupled over bus circuitry. UE 501 is wirelessly coupled to antennas in RU 511 over 5GNR links. Transceivers in RU 511 are coupled to transceivers in DU 512 over fronthaul links like enhanced Common Public Radio Interface (eCPRI). The DSPs in RU 511 executes their operating systems and radio applications to exchange 5GNR signals with UE 501 and to exchange 5GNR data with DU 512.

For the uplink, the antennas in RU 511 receive wireless signals from UE 501 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 512 over the transceivers.

For the downlink, the DSPs receive downlink 5GNR symbols from DU 512. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink 5GNR signaling and data.

DU 512 comprises memory, CPU, and transceivers that are coupled over bus circuitry. The memory in DU 512 stores operating systems and 5GNR network applications like PHY, MAC 702, and RLC. CU 513 comprises memory, CPU, and transceivers that are coupled over bus circuitry. The memory in CU 513 stores an operating system, 5GNR network applications like PDCP, SDAP, and RRC 701, and machine learning model (ML) 703. Transceivers in DU 512 are coupled to transceivers in RU 511 over front-haul links. Transceivers in DU 512 are coupled to transceivers in CU 513 over mid-haul links.

RLC functions comprise ARQ, sequence numbering and resequencing, segmentation and resegmentation. MAC 702 functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC 701 functions include authentication, security, handover control, status reporting, QoS, network broadcasts and pages, network selection, SINR calculation, transmitter power tracking, feature vector preparation, and cell bandwidth control. Machine learning model 703 functions include uplink PRB allocation, transmit power selection, and radio resource requirement prediction.

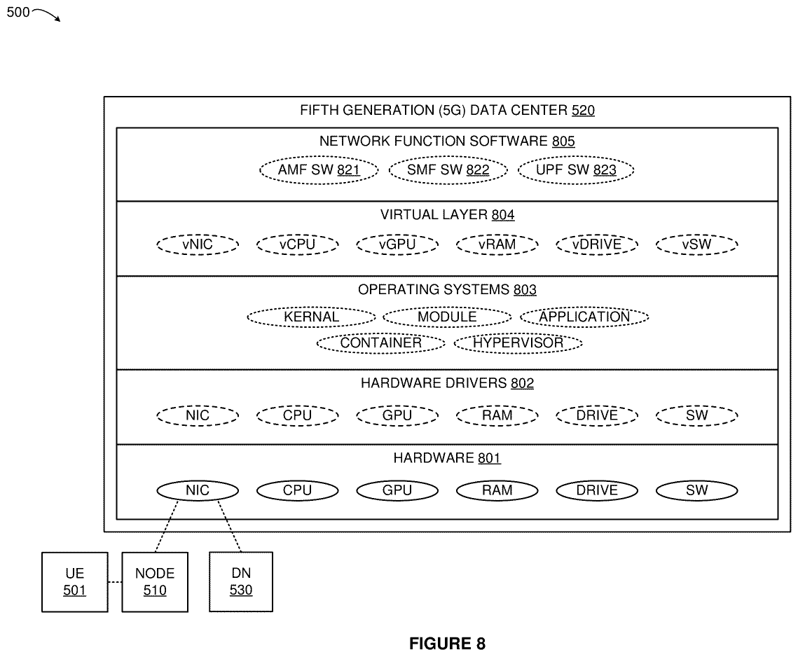

FIG. 8 illustrates 5G data center 520 in 5G communication network 500. 5G data center 520 comprises an example of core network 120 illustrated in FIG. 1, although core network 120 may differ. 5G data center 520 typically comprises a virtualized computing architecture like NFVI, but may comprise another computing architecture like a cloud computing network, a hybrid cloud network, and the like. 5G data center 520 comprises hardware 801, hardware drivers 802, operating systems 803, virtual layer 804, and network function software 805. Hardware 801 comprises Network Interface Cards (NICs), CPU, GPU, RAM, Flash/Disk Drives (DRIVE), and Data Switches (SW). Hardware drivers 802 comprise software that is resident in the NIC, CPU, GPU, RAM, DRIVE, and SW. Operating systems 803 comprise kernels, modules, applications, containers, hypervisors, and the like. Virtual layer 804 comprises vNIC, vCPU, vGPU, vRAM, vDRIVE, and vSW. Network function software 805 comprises AMF Software (SW) 821, SMF SW 822, and UPF SW 823. Additional network function software for network functions like AUST, NSSF, PCF, UDM, UDR, CHF, HLR, HSS, NRF, SMSF, NEF, AF, EIR, and SCP is typically present but is omitted for clarity. 5G data center 520 may be located at a single site or be distributed across multiple geographic locations. The NIC in hardware 801 is coupled to 5G gNodeB 510, data network (DN) 530, and to external systems (not illustrated). Hardware 801 executes hardware drivers 802, operating systems 803, virtual layer 804, and network function software 805 to form AMF 521, SMF 522, and UPF 523.

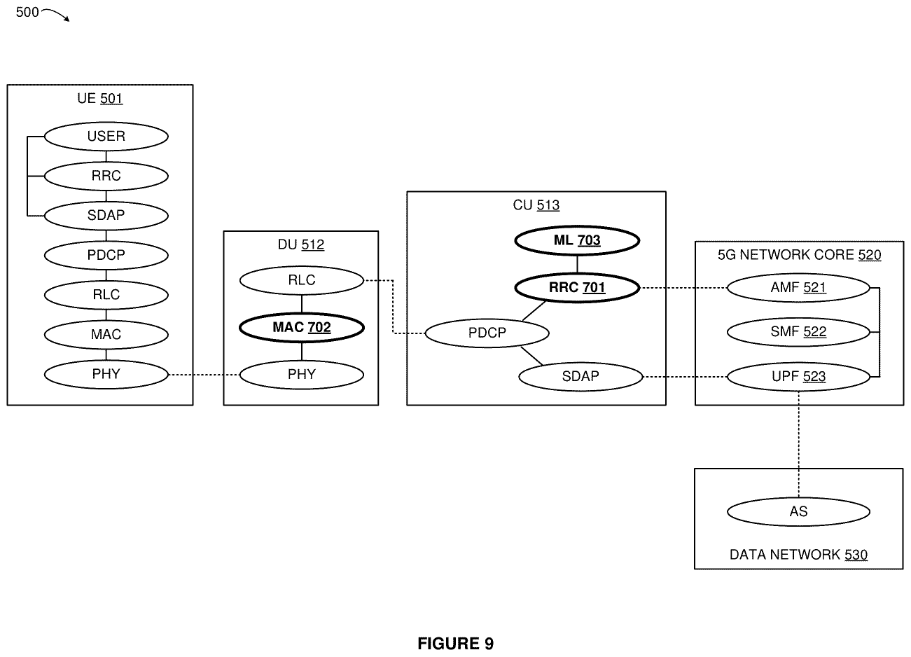

FIG. 9 illustrates an exemplary operation of 5G communication network 500 to utilize a machine learning model to mitigate IMD. The exemplary operation comprises an example of processes 200 and 300 illustrated in FIGS. 2 and 3, however processes 200 and 300 may differ. The exemplary operation may differ in other examples. In some examples, RRC 701 directs SDAP to serve a PDU session to UE 501 in response to receiving a registration accept message from AMF 521. RRC 701 in UE 501 directs the PHY to measure SINR at the location of UE 501. The PHY analyzes the signal from UE 501 and other UEs attached to 5G gNodeB 510 to measure the received power from UEs attached to 5G gNodeB 510 and from interference sources. The PHY provides the measurements to the RRC which then calculates SINR. RRC 701 determines the current transmit power used by RU 511 to transmit downlink signaling and data to UE 501. RRC 701 determines the current loading, time, day of the week, and date. RRC 701 generates feature vectors that represent the current transmit power, the SINR, the loading, time, day, and date and provides the feature vectors to machine learning model 703.

Machine learning model 703 processes the feature vectors that represent the loading, time, day, and date and to predict upcoming radio resource requirements. For example, the radio resource prediction may comprise the predicted number of PRBs needed to support uplink and downlink communications in the near term (e.g., 0.5-10 minutes). Machine learning model 703 processes the feature vectors that represent current transmit power and SINR to recommend an uplink PRB allocation and downlink transmit power that maximizes uplink bandwidth usage without introducing IMD in the receiver in RU 511, that maximizes downlink transmit power without desensitizing the receiver in RU 511, that minimizes BLER, and that minimizes retransmission rate. Machine learning model 703 transfers a machine learning output that comprises the predicted radio resource requirements, the recommended uplink PRB allocation, and the recommended downlink transmit power.

RRC 701 sets the downlink transmit power of RU 511 to the power level recommended by machine learning model 703. RRC 701 interfaces with MAC 702 to reserve radio resources for the upcoming transmission period based on the radio resource requirements predicted by machine learning model 703. RRC 701 directs MAC 702 to schedule UE 501 for wireless service using the uplink PRBs recommended by machine learning model 703. MAC 702 schedules UE 501 downlink transmissions in downlink PRBs. MAC 702 schedules UE 501 for uplink transmissions in the uplink PRBs allocated by machine learning model 703. RRC 701 indicates the scheduled uplink and downlink PRBs to the RRC in UE 501 over the PDCPs, RLCs, MACs, and PHYs. The RRC in UE 501 controls the lower layer network applications to send/receive signaling and data in the scheduled PRBs.

The user application in UE 501 and the AS in data network 530 generate user data for the session. The SDAP in UE 501 exchanges the user data with the SDAP in CU 513 over the PDCPs, RLCs, MACs, and PHYs using the uplink and downlink PRBs scheduled by MAC 702. The SDAP in CU 513 exchanges the user data with UPF 523. UPF 523 exchanges the user data with data network 530. SMF 522 monitors and controls UPF 523 to support the session.

The wireless data network circuitry described above comprises computer hardware and software that form special-purpose network circuitry to utilize a machine learning model to mitigate IMD. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to utilize a machine learning model to mitigate IMD.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
generating feature vectors based on a transmit power metric and Signal-To-Interference-Plus Noise Ratio (SINR) metric for a wireless access node;
processing the feature vectors using a machine learning model to generate a machine learning output that predicts an uplink Physical Resource Block (PRB) allocation, wherein the machine learning model is trained to determine uplink PRB allocations based on metrics of wireless access nodes, wherein the metrics include transmit power metrics and SINR metrics; and
scheduling uplink PRBs based on the uplink PRB allocation determined by the machine learning model.

2. The method of claim 1 wherein the uplink PRB allocation determined by the machine learning model mitigates Intermodulation Distortion (IMD) in uplink signals; and further comprising:
determining radio resources available at the wireless access node are unable to support the uplink PRB allocation determined by the machine learning model; and
in response, reducing uplink bandwidth available for use by the wireless access node to mitigate the IMD in uplink signals.

3. The method of claim 2 further comprising:
subsequently, determining the radio resources available at the wireless access node are able to support the uplink PRB allocation determined by the machine learning model; and
in response, increasing the uplink bandwidth available for use by the wireless access node.

4. The method of claim 1 wherein the uplink PRB allocation determined by the machine learning model maximizes uplink bandwidth usage without introducing the Intermodulation Distortion (IMD) in uplink signals.

5. The method of claim 1 further comprising:
generating training feature vectors that represent historical transmit power metrics, historical SINR metrics, historical uplink PRB allocations, and historical Intermodulation Distortion (IMD) in uplink signals for the wireless access node; and
utilizing the machine learning model to process the training feature vectors to train the machine learning model to correlate reductions in the historical IMD in the uplink signals at corresponding ones of the historical transmit power metrics and ones of the historical SINR metrics with ones of the historical uplink PRB allocations.

6. The method of claim 1 wherein scheduling the uplink PRBs based on the uplink PRB allocation determined by the machine learning model comprises scheduling, by a Media Access Control (MAC) executed by the wireless access node, the uplink PRBs based on the uplink PRB allocation determined by the machine learning model.

7. The method of claim 1 wherein the wireless access node comprises a Fifth Generation New Radio (5GNR) gNodeB.

8. A system comprising:
processing circuitry in a wireless access node configured to:
generate feature vectors based on a transmit power metric and Signal-To-Interference-Plus Noise Ratio (SINR) metric for a wireless access node;
process the feature vectors using a machine learning model to generate a machine learning output that predicts an uplink Physical Resource Block (PRB) allocation, wherein the machine learning model is trained to determine uplink PRB allocations based on metrics of wireless access nodes, wherein the metrics include transmit power metrics and SINR metrics; and
schedule uplink PRBs based on the uplink PRB allocation determined by the machine learning model.

9. The system of claim 8 wherein:
the uplink PRB allocation determined by the machine learning model mitigates Intermodulation Distortion (IMD) in uplink signals; and
the processing circuitry is further configured to:
determine radio resources available at the wireless access node are unable to support the uplink PRB allocation determined by the machine learning model; and
in response, reduce uplink bandwidth available for use by the wireless access node to inhibit the IMD in the uplink signals.

10. The system of claim 9 wherein the processing circuitry is further configured to:
subsequently, determine the radio resources available at the wireless access node are able to support the uplink PRB allocation determined by the machine learning model; and
in response, increase the uplink bandwidth available for use by the wireless access node.

11. The system of claim 8 wherein the uplink PRB allocation determined by the machine learning model maximizes uplink bandwidth usage without introducing the Intermodulation Distortion (IMD) in uplink signals.

12. The system of claim 8 wherein the processing circuitry is further configured to:
generate training feature vectors that represent historical transmit power metrics, historical SINR metrics, historical uplink PRB allocations, and historical Intermodulation Distortion (IMD) in uplink signals for the wireless access node; and
utilize the machine learning model to process the training feature vectors to train the machine learning model to correlate reductions in the historical IMD in the uplink signals at corresponding ones of the historical transmit power metrics and ones of the historical SINR metrics with ones of the historical uplink PRB allocations.

13. The system of claim 8 further comprising a Media Access Control (MAC); and wherein the processing circuitry is further configured to:
execute the MAC; and wherein:
the MAC is configured to schedule the uplink PRBs based on the uplink PRB allocation determined by the machine learning model.

14. The system of claim 8 wherein the wireless access node comprises a Fifth Generation New Radio (5GNR) gNodeB.

15. One or more non-transitory computer readable storage media having program instructions stored thereon, wherein the program instruction, when executed by a computing system, direct the computing system to perform operations, the operations comprising:
generating feature vectors based on a transmit power metric and Signal-To-Interference-Plus Noise Ratio (SINR) metric for a wireless access node;
processing the feature vectors using a machine learning model to generate a machine learning output that predicts an uplink Physical Resource Block (PRB) allocation, wherein the machine learning model is trained to determine uplink PRB allocations based on metrics of wireless access nodes, wherein the metrics include transmit power metrics and SINR metrics; and
scheduling uplink PRBs based on the uplink PRB allocation determined by the machine learning model.

16. The computer readable storage media of claim 15 wherein the uplink PRB allocation determined by the machine learning model mitigates Intermodulation Distortion (IMD) in uplink signals; and wherein the operations further comprise:
determining radio resources available at the wireless access node are unable to support the uplink PRB allocation determined by the machine learning model; and
in response, reducing uplink bandwidth available for use by the wireless access node to mitigate the IMD in uplink signals.

17. The computer readable storage media of claim 16 wherein the operations further comprise:
subsequently, determining the radio resources available at the wireless access node are able to support the uplink PRB allocation determined by the machine learning model; and
in response, increasing the uplink bandwidth available for use by the wireless access node.

18. The computer readable storage media of claim 15 wherein the uplink PRB allocation determined by the machine learning model maximizes uplink bandwidth usage without introducing the Intermodulation Distortion (IMD) in uplink signals.

19. The computer readable storage media of claim 15 further comprising:
generating training feature vectors that represent historical transmit power metrics, historical SINR metrics, historical uplink PRB allocations, and historical Intermodulation Distortion (IMD) in uplink signals for the wireless access node; and
utilizing the machine learning model to process the training feature vectors to train the machine learning model to correlate reductions in the historical IMD in the uplink signals at corresponding ones of the historical transmit power metrics and ones of the historical SINR metrics with ones of the historical uplink PRB allocations.

20. The computer readable storage media of claim 15 wherein scheduling the uplink PRBs based on the uplink PRB allocation determined by the machine learning output comprises utilizing a Media Access Control (MAC) executed by the wireless access node to schedule the uplink PRBs based on the uplink PRB allocation determined by the machine learning output.
